(19) United States
(12) Patent Application Publication
(10) Pub. No.: US 2006/0290681 A1
(43) Pub. Date: Dec. 28, 2006

(54) METHOD FOR ZOOMING IMAGE ON TOUCH SCREEN

(76) Inventors: Liang-Wei Ho, Taoyuan (TW); Po-Yu Shih, Taoyuan (TW); Yuen-Lin Chung, Taoyuan (TW)

Correspondence Address: HOFFMAN WARNICK & D'ALESSANDRO, LLC, 75 STATE STREET, 14TH FLOOR, ALBANY, NY, 12207, US

(21) Appl. No.: 11/424,884

(22) Filed: Jun. 19, 2006

(30) Foreign Application Priority Data
Jun. 24, 2005 (TW) 094121174

(51) Int. Cl. G09G 5/00

(52) U.S. Cl. 345/173

(57) ABSTRACT

The invention provides a method for switching the size of an image displayed on a touch screen between a full-screen size and a normal size. A user can selectivity display the image on the touch screen in the full-screen size or the normal size by use of the method according to the invention. A user interface is previously defined. The user interface includes a first level, where a plurality of application icons are previously defined, and a second level wherein the image is previously defined. When the image is displayed on the touch screen in the full-screen size, the image covers the application icons which are not closed.

### BACKGROUND OF THE INVENTION

1. Field of the Invention

This present invention relates to a method for switching the size of an image, and more particularly, to a method for switching the size of an image, displayed on a touch screen, between a full-screen size and a normal size. A signal can be induced by an external force imposed on the touch screen, and the size of the image is switched according to the signal and the present displayed size of the image.

2. Description of the Prior Art

Before touch screen is invented, switching the size of an image displayed on a screen is done via using at least one button set on the peripheral of the screen. After using the at least one button set on the peripheral of the screen, a graphical user interface is predefined on the screen. A user can switch the size of the image displayed on the screen via a mouse or other input device.

After the touch screen was invented, a user can switch the size of the image displayed on the screen without using a mouse or other input device. The user can switch the size of the image displayed on the screen by imposing an external force on the touch screen.

However, it is not always easy for the user to impose an external force precisely on the specific position of the touch screen. If the touch screen is used in an electronic equipment installed in a car, it must be considered that the space in the car is smaller than an ordinary room. The above problem in which the user can not precisely impose an external force on the specific position of the touch screen will be more obvious. As a result, it is necessary to provide a method for conveniently switching the size of an image displayed on a screen, so as to solve problems mentioned above. For this reason, the inventor shows his creativity and develops his invention to the best. Therefore, this invention is created.

### SUMMARY OF THE INVENTION

A scope of the invention is to provide a method for switching the size of an image displayed on a touch screen. The method according to the invention utilizes a signal induced by an external force imposed on the touch screen. If the external force is imposed at a position on the touch screen that is within a region of the touch screen covered by the image, the signal will trigger the switching of the size of the image. Another scope of the invention is to provide a method for switching the size of an image displayed on a touch screen. The method provides two different display sizes, such that the image can be displayed in the full-screen size or in the normal size.

Another scope of the invention is to provide a method for switching the size of an image displayed on a touch screen. Using the method, while the image is displayed in the full-screen size, a plurality of application icons are pre-defined on a first level of a user interface, and the image is pre-defined on a second level of the user interface higher than the first level, and the image covers the application icons which are not closed.

According to the preferred embodiment of the present invention, the problem of the prior art, in which a user cannot precisely impose an external force on a specific position on the touch screen to switch the size of the image via the graphical user interface, can be resolved. In other words, an external force is imposed on a predetermined area of the touch screen, such that it is easy to switch the size of the image displayed on the touch screen.

The advantage and spirit of the invention may be understood by the following recitations together with the appended drawings.

### BRIEF DESCRIPTION OF THE APPENDED DRAWINGS

FIG. 1 is a schematic diagram illustrating the image displayed in the full-screen size according to the preferred embodiment of the present invention.

FIG. 2 is a schematic diagram illustrating the image displayed in the normal size according to the preferred embodiment of the present invention.

FIG. 3 is a flow chart diagram illustrating the method for switching the size of the image.

### DETAILED DESCRIPTION OF THE INVENTION

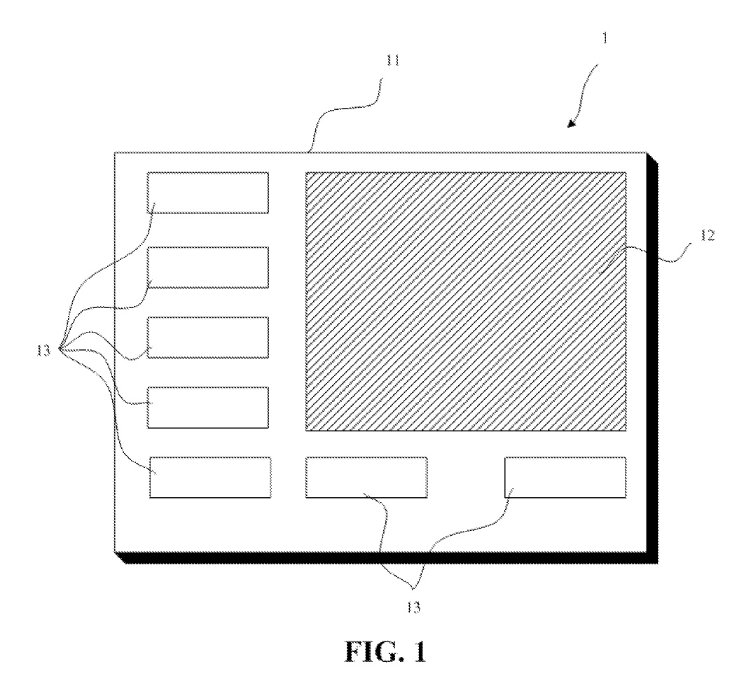

Referring to FIG. 1, FIG. 1 is a schematic diagram illustrating the image 12 displayed in the full-screen size according to a preferred embodiment of the present invention. The image 12 is displayed in a normal size on a touch screen 11 of a monitor 1. The touch screen 11 can receive an external force. A signal can be induced by an external force imposed on the touch screen 11. A plurality of application icons 13 are pre-defined on a first level of the interface. The plurality of application icons 13 are used to control an electronic equipment (not shown) equipped with the monitor 1 and the touch screen 11. For example, one of the functions of the plurality of application icons 13 is to choose one signal source for the monitor 1. The image is pre-defined on a second level of the interface.

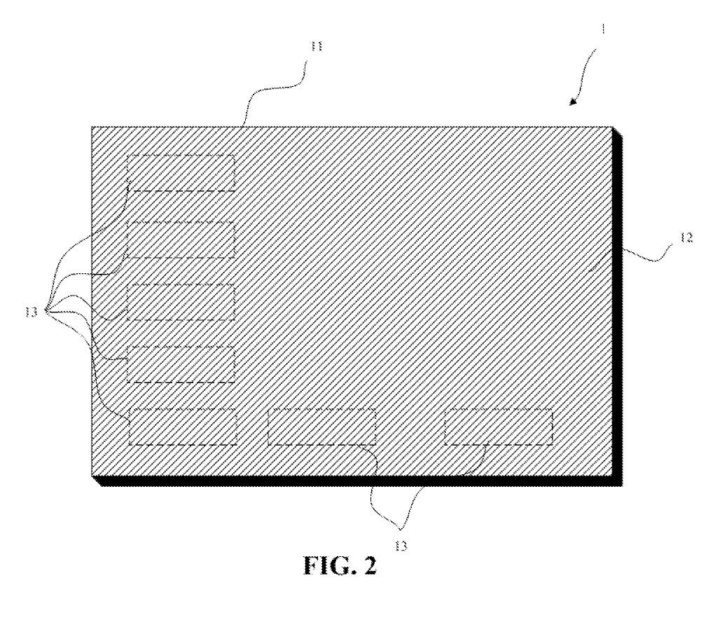

Refer to FIG. 2, FIG. 2 is a schematic diagram illustrating the image displayed in the full-screen size according to the preferred embodiment of the present invention. The image 12 is displayed in a full-screen size on the touch screen 11 of the monitor 1. The image 12 is previously defined on the second level. The plurality of application icons 13, as shown in FIG. 1, are previously defined on the first level. The second level of the user interface is higher than the first level. When the image 12 is displayed on the touch screen 11 in the full-screen size, the image 12 covers the application icons which are not closed.

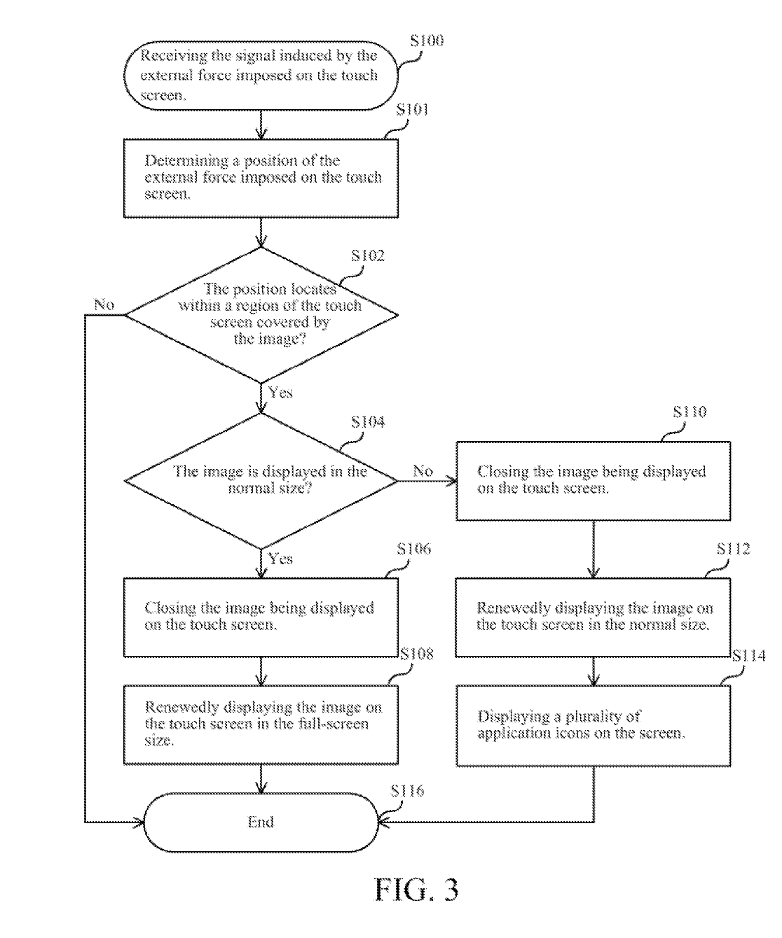

Referring to FIG. 3, FIG. 3 is a flow chart diagram illustrating the method how to switch the size of the image. The same description as in FIG. 1 and FIG. 2 will not be described repeatedly. According to the preferred embodiment of the invention, it is used to judge if the position of the external force imposed on the touch screen is located within the region of the touch screen 11 covered by the image. If YES, then the present displayed size is switched. According to the preferred embodiment of the invention, first, step S100 is executed to receive the signal induced by the external force imposed on the touch screen. Afterward, step S101 is executed to determine, according to the signal, a position of the external force imposed on the touch screen. Then, step S102 is executed to judge if the position is located within a region of the touch screen covered by the image. If YES in step S102, then step S104 is executed to judge if the size of the image being displayed is the normal size. If NO in step S102, then step S116 is executed to end the method.

If YES in step S104, then step S106 is executed to close the image being displayed on the touch screen. Then, S108 is executed to renewedly display the image on the touch screen in the full-screen size. After step S108, step S116 is executed to end.

If NO in step S104, then step S110 is executed to close the image being displayed on the touch screen. Then, step S112 is executed to renewedly display the image on the touch screen in the normal size. After step S112, step S116 is executed to end the method.

Comparing to prior art, a user can precisely impose an external force on a specific position of the graphical user interface. Even if the touch screen is used in an electronic equipment installed in a car, the user can easily switch the size of the image displayed on the touch screen.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A method for switching a size of an image displayed on a touch screen between a first size and a second size, said method comprising the steps of:
(a) displaying the image on the touch screen in one of the first size and the second size;
(b) receiving a signal induced by an external force imposed on the touch screen;
(c) determining, according to the signal, a position of the external force imposed on the touch screen, and judging if the position is located within a region of the touch screen covered by the image being displayed; and
(d) if YES in step (c), displaying the image on the touch screen in the other of the first size and the second size.

2. The method of claim 1, wherein the first size is a normal size, and the second size is a full-screen size.

3. The method of claim 2, wherein step (d) is implemented by the steps of:
(d1) if YES in step (c), judging if the size of the image being displayed is the normal size; and
(d2) if YES in step (d1), closing the image being displayed on the touch screen, and renewedly displaying the image on the touch screen in the full-screen size.

4. The method of claim 3, wherein step (d) also comprises the step of:
(d3) if NO in step (d1), closing the image being displayed on the touch screen, and renewedly displaying the image on the touch screen in the normal size.

5. The method of claim 4, wherein after step (d3), step (d) also comprises the step of:
(d4) displaying a plurality of application icons on the touch screen.

6. The method of claim 5, wherein the plurality of application icons are previously defined on a first level of a user interface, the image is previously defined on a second level of the user interface higher than the first level, and when the image is displayed on the touch screen in the full-screen size, the image covers the application icons which are not closed.
